(19) United States
(12) Patent Application Publication
(10) Pub. No.: US 2026/0329699 A1
(43) Pub. Date: Oct. 22, 2026

(54) BACKUP USING DATA OBJECT PORTION RELATIONSHIPS

(71) Applicant: Salesforce, Inc., San Francisco, CA (US)

(72) Inventors: Jason K. S. Choy, Short Hills, NJ (US); Srinivas Mallavadhani Garikipati, TELANGANA (IN)

(21) Appl. No.: 19/180,823

(22) Filed: Apr. 16, 2025

(51) Int. Cl. G06F 11/14

(52) U.S. Cl. CPC G06F 11/1451; G06F 11/1461

(57) ABSTRACT

Methods, systems, and apparatus, including computer programs encoded on computer storage media, for backup up data using data object relationships. One of the methods includes determining, using priority data, to backup a first proper subset of data portions from a first data object, the first data object including the first proper subset and a second proper subset; determining, using relationship data that identifies relationships between data portions of different data objects from a plurality of data objects, to backup a third proper subset of data portions from a second, different data object, the second, different data object including the third proper subset and a fourth proper subset; determining, using the priority data, to skip a backup process for the second proper subset and fourth proper subset; and initiating backup of the first proper subset and the third proper subset.

### FIELD

This specification describes technologies for backing up data. These technologies generally involve determining backup actions for data based on the particulars of the data.

### BACKGROUND

Backing up data can be an important part of digital processing systems. Should systems crash, secondary backup storage is required to recover data lost during the system crash.

### BRIEF DESCRIPTION OF THE DRAWINGS

FIG. 1 shows an example backup environment.

FIG. 2 is a flowchart of an example process for backing up data.

FIG. 3 depicts an example environment in which a backup system backs up subsets of data objects using relationships between the subsets.

FIG. 4 is a flow diagram of an example process for backing up related data portions.

Like reference numbers and designations in the various drawings indicate like elements.

### DETAILED DESCRIPTION

A backup system can back up a target system to reduce a likelihood that data in the target system will be lost. Sometimes it might be practically impossible for the backup system to backup all data for the target system, such as a software as a service (“SaaS”) or another appropriate type of storage. This might occur when the sizes of data objects for the target system do not satisfy a size threshold, e.g., are too large, a backup of the entirety of all data objects would take too long, an interface for requesting data does not allow an entire backup, or any combination of these. For instance, an application programming interface (“API”) might not have the functionality to allow an entire backup but might only allow for a partial backup.

The backup system can determine target fields in the data objects at the target system that satisfy one or more backup criteria and backup those target fields. The backup criteria can require that the target fields are most frequently read, most frequently updated, or both, compared to other fields. A data read or a data update can be generally referred to as data access. The backup criteria can indicate that one or more other related fields, that are related to the target fields, and backup those related fields. The backup system can determine the related fields using the backup criteria that indicate a minimum level of relationship between other fields and the target fields such that the other fields are related. This can include a maximum dependency level, a frequency criterion, or both.

The backup system can generate a query for a backup process using data for the target fields and the related fields. The data can include identifiers for the fields or other appropriate data. The backup system can perform this process dynamically for a backup time period, e.g., can determine the target fields and related fields, and generate a corresponding query, for the backup time period. This can allow for dynamic changes in which fields should be backed-up during any particular backup process.

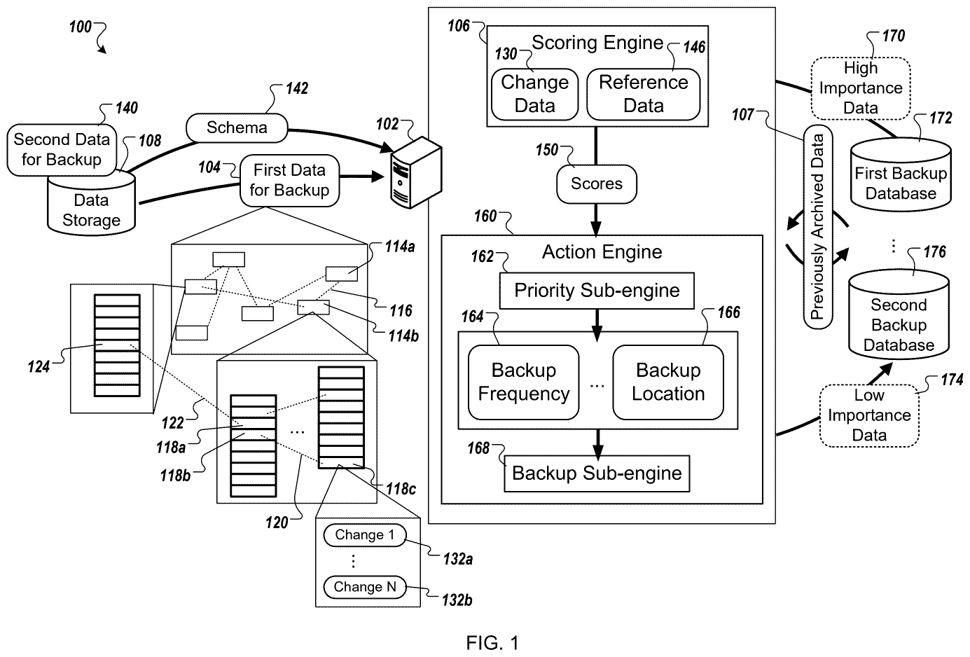

FIG. 1 shows an example backup environment 100. In general, previously archived data, schema of data for backup, or both, can be used to prioritize the backing up data for another backup process. The previously archived data can be used to determine changes in one or more data objects also included in the data for another backup process. The schema can indicate relationships between data objects, e.g., included in one or both the previously archived data and data for another backup process. A backup system 102 of the environment 100 can determine a number of changes, relationships for one or more data objects, or both, to prioritize the backup of those data objects in the data for backup.

The backup environment 100 includes a backup system 102, data storage 108, a first backup database 172, and a second backup database 176. The backup system 102, the data storage 108, the first backup database 172, or the second backup database 176, or a combination of these can be connected using one or more networks to exchange data.

The backup system 102 maintains, for the first data for backup 104 from the data storage 108, a previously archived data 107. The first data for backup 104 can be any appropriate type of data for backup, such as a snapshot of part or all of the data storage 108. The first data for backup 104 can include data representing changes made to one or more data objects, e.g., change 1 132a and change N 132b, representing one or more changes compared to an earlier snapshot for the data storage 108, e.g., the previously archived data 107.

The backup system 102 can back up the first data for backup 104 generating previously archived data 107 prior to generating scores for subsequent data. The previously archived data 107 can include data objects, fields, or relationships shown as included in the first data for backup 104. A data object can be an entry in a table, e.g., a row or a column in the table.

A scoring engine 106, using the previously archived data 107 determines change data 130 indicating changes—e.g., number of additions, modifications, deletions—to data within the first data for backup 104. The scoring engine 106 can obtain the previously archived data 107 from one or more storage databases, e.g., a first backup database 172 or second backup database 176. The scoring engine 106, using the previously archived data 107, can parse the changes 132a-b to generate the change data 130. The scoring engine 106 can use a number of changes, a number of different types of changes, or both, that were made to a data object to determine an importance score for that data object.

The backup system 102 receives the schema 142 from the data storage 108. The schema 142 indicates relationships between data objects of the second data for backup 140. The second data for backup 140 can include one or more data objects in common with the first data for backup 104 and the previously archived data 107. Some of these common data objects can be modified or different between various backup processes. For instance, the second data for backup 140 can represent a state of data, e.g., from SaaS or other data sources, subsequent in time from the first data for backup 104.

The scoring engine 106 of the backup system 102 can use the schema 142 to generate reference data 146. The schema 142 can indicate one or more relationships between data objects or fields within data objects of the second data for backup 140. The schema represents relationships between data objects or fields, e.g., similar to the relationships shown as included in the first data for backup 104. The schema can include data indicating a relationship between two or more data objects or fields but need not necessarily include the actual data objects or fields, e.g., a name indicating a particular data object or field sufficient to represent a relationship without storing contents of the data object or field. Relationships can include a data object or data field referencing another data object or field, e.g., as shown in FIG. 1 in regard to the first data for backup 104. In general, more references to or from a data object can indicate greater importance for the data object compared to another data object with fewer references to or from itself, e.g., within a SaaS data set. The scoring engine 106 can parse the schema 142 to obtain an indication of one or more relationships between one or more data objects or fields of the second data for backup 140. The scoring engine 106 can use the indications of the one or more relationships as the reference data 146.

In some implementations, the backup system 102 backs up the schema 142. For example, the backup system 102 can backup the schema 142 before using the schema 142 to generate one or more scores, during the process to back up the second data for backup 140, or a combination of both.

The scoring engine 106 generates scores 150 using the change data 130, the reference data 146, or both. In some implementations, generating the scores 150 includes generating an impact ratio and entity rank for one or more data objects. For example, generating an impact ratio can include performing one or more operations represented in the pseudocode in Table 1, below, where a number of changes can be determined using the change data 130.

TABLE 1
Pseudocode for generating impact ratio

```
Entity Ei where i=1 . . ., N, N is the total number of entities
Change ECi, Entity Modify EMi, Entity Creation, EAi, Entity Deletion,
EDi
Weight of Importance for Create a, Modify m, Delete d
Impact Ratio IRj where i=1...N is the corresponding ratio to Ei
TotalChange TC =0
For j=1 to N
{
  ECj = m * EMj + a *EAj + d * EDj
  TC = TC + ECj
}
For j=1 to N
{
  IRj = exp (ECj / TC)
}
```

Generating an entity rank can include performing one or more operations represented in the pseudocode in Table 2, below, where a number of references can be determined using reference data 146.

TABLE 2
Pseudocode for generating entity rank

```
Entity Ei where i=1 . . ., N, N is the total number of entities
Field Fij is the field j in Entity i
NFi is the number of fields in Entity i
ERi is the EntityRank for Ei, initialized to 0
For i=1 to N {scanning through each entity}
  For j=1 to NFi {scanning through each field in the entity}
    If Fij has reference to Entity x
      ERx = ERx +1
Metadata artifacts
For k=1 to M {scanning through each metadata artifacts - assume the total
is M}
  For l=1 to N {scanning through all the entity}
    If MetaDataArtifact.k has reference to Entity 1
      ERl = ERl + 1
```

In some implementations, ER includes an indication of other obtained data. For example, ER can include an indication of metadata artifacts such as programs, triggers, screens, report, layout, or a combination of these. An indication can include a number of references within the metadata artifacts to a given entity. In some implementations, metadata artifacts are used similar to other data objects—e.g., where a reference within an artifact to a data object will increase the ER of that data object.

In some implementations, generating the scores 150 includes generating a measure of importance using a generated value for impact ratio and entity rank. For example, generating a measure of importance can include performing one or more operations represented in the pseudocode in Table 3, below, where IR can represent an impact ratio generated by the scoring engine 106 using the change data 130 and ER can represent an entity rank generated by the scoring engine 106 using the reference data 146. Although the example in Table 3 uses multiplication, other examples can use any other appropriate combination operator, e.g., addition, exponential, or a weighted combination operator.

TABLE 3
Pseudocode for generating entity importance

N is the total number of entities
For i= 1 to N
EntityImportance EI[i] = ER[i] * IR[i]

The action engine 160 of the backup system 102 uses the scores 150 to prioritize the backup of data objects included in the second data for backup 140. The action engine 160 includes a priority sub-engine 162 and a backup sub-engine 168. The action engine 160 can prioritize the backup of data in a number of ways. For example, the action engine 160 can generate a backup frequency 164 indicating some more important objects to be backed up more frequently than other, less important, objects. The action engine 160 can select a backup location 166 indicating some more important objects to be backed up in a first database with faster read or write times and other, less important, objects to be backed up in a second database with slower read or write times compared to the first database. The first backup database 172 and the second backup database 176 can be examples of backup databases with different storage costs, capabilities, or both. The action engine 160 can determine a priority for one or more data objects and backup high importance data 170 using the first backup database 172 and low importance data 174 using the second backup database 176.

The priority sub-engine 162 uses the scores 150 to determine a priority of data objects for backing up. In some implementations, the priority sub-engine 162 sorts one or more data objects using corresponding scores in the scores 150, generates a priority ranking of the data objects, or a combination of both. For example, the priority sub-engine 162 can sort a first data object as more important than a second data object using a generated score—e.g., based on the first data object having been changed more often or referenced more often compared to the second data object. The action engine 160 can determine actions to perform on objects using descending scores—e.g., performing operations, such as backup, on more important data objects corresponding to higher scores before less important data objects corresponding to lower scores.

The action engine 160 uses a priority determined by the priority sub-engine 162 to prioritize backup, e.g., by selecting or otherwise changing a backup frequency, backup location, number of backup copies stored, or a combination of these. The backup sub-engine 168 uses determined backup prioritizations—e.g., frequency, backup location, number of copies, or a combination of these—to backup data in one or more databases. For example, the backup sub-engine 168 can backup a first portion of the second data for backup 140 in the first backup database 172 and a second portion of the second data for backup 140 in the second backup database 176 using the backup location 166 generated by the action engine 160. The backup sub-engine 168 can backup a first portion of the second data for backup 140 every hour and a second portion of the second data for backup 140 every four hours using the backup frequency 164 generated by the action engine 160. Of course, frequencies other than one hour and four hours can be used, e.g., a number of seconds, minutes, hours, days, weeks, months, years, among others.

In some instances, the second data for backup 140 does not have a stored schema. In these instances, the scoring engine 106 of the backup system 102 can determine reference data 146 using one or more relationships determined from one or more previous backups, e.g., the change data 130. For example, the scoring engine 106 can parse the first data for backup 104 to identify one or more relationships—e.g., data objects 114a and 114b related by object relationship 116. The object relationship 116 can indicate that the first data object 114a references data in the second data object 114b. The object relationship 116 can indicate that one or more data fields of the first data object 114a are used in data fields of the second data object 114b or vice versa. The scoring engine 106 can parse data for the first data for backup 104 to identify one or more relationships between data fields. The data can be metadata or other appropriate data given data access, e.g., privacy, permissions.

The second data object 114b includes data fields 118a-c. The data fields 118a-c can be related to one another. For example, the second data field 118b is related to the third data field 118c by a first field relationship 120. The first data field 118a is related to another data field 124 of another data object by a second field relationship 122. The first field relationship 120 and the second field relationship 122 can indicate that the fields are using other field values, e.g., in a composite value or for calculating a new value.

In some instances, the first data for backup 104 is stored in one or more of the first backup database 172 or the second backup database 176, e.g., using the backup location 166. Data objects of the data for backup 104 that are of high importance can be stored separately from data objects of comparatively low importance when importance can be determined using generated scores as described in this specification. Storing more important data objects separately can improve efficiency of storage or retrieval—e.g., because more important data objects are more likely to be changed, requiring one or more additional backups; or are more likely to be used, requiring more data retrieval; or both. To help improve efficiency of storage or retrieval, more important data objects can be stored in memory with higher read or write efficiency.

The backup system 102 can update scores for data objects. In some implementations, the backup system 102 updates scores for data objects periodically, e.g., every backup or according to another schedule. In some implementations, the backup system 102 updates scores for data objects if a change in schema is detected, e.g., by the backup system 102. In some implementations, the backup system 102 updates scores for data objects if a change is detected. For example, a first data object can have a score associated with it that is generated by the scoring engine 106. If the first data object changed, according to a last backup of the first data object, the scoring engine 106 can determine that the first data object changed and update a score for the first data object in response. If a schema that represents the first data object changed, the scoring engine 106 can similarly generate an updated score for the first data object in response.

In some implementations, only a rank is updated when the scoring engine 106 determines schema has changed, e.g., and not an impact ratio. For example, as described in this specification, a rank can be generated for one or more data objects in data to be backed up using a schema. An impact ratio can be generated using changes in data objects—e.g., as recorded in a previous one or more backups. A score can be generated by combining these values. If a schema changes, an impact ratio can remain the same—e.g., if the number of changes previously recorded have not changed—but the rank of one or more data objects might change. In response, the scoring engine 106 can update the reference data 146 but not the change data 130 to be used for generating the scores 150 for the data objects.

In some implementations, the backup system 102 determines priority for the second data for backup 140 without previously obtaining the first data for backup 104. For example, the backup system 102 can obtain a schema or other data representing the second data for backup 140. The backup system 102 can generate scores using the reference data 146 generated from data representing the second data for backup 140. The scores can be updated—e.g., to include one or more past changes-when subsequently backing up data included in the second data for backup 140.

In some implementations, the first data for backup 104 is processed similar to the second data for backup 140. For example, the scoring engine 106 can generate scores for prioritizing backup of the first data for backup 104. In some instances, the backup system 102 uses a backup prior to the first data for backup 104 to obtain changes for data objects of the first data for backup 104.

In some implementations, scores for prioritizing storage of the first data for backup 104 to generate the previously archived data 107 can be generated using prior backups or data representing the first data for backup 104, e.g., schema, the data itself, or a combination of both. The previously archived data 107 can be used to generate scores for subsequent data, e.g., subsequent data that includes data objects in common with the previously archived data 107. For instance, when the first data for backup 104 is a first backup ever made for the data storage 108, the backup system 102 can use data representing the first data for backup 104 to prioritize backing up data objects of the first data for backup 104. For example, the backup system 102 can obtain a schema of the first data for backup 104, either separately or based on processing the first data for backup 104. The backup system 102 can obtain changes of the first data for backup 104 by processing the first data for backup 104. In some implementations, the backup system 102 backs up the first data for backup 104 without using any change data to determine the scores. For example, the backup system 102 can use only schema data, e.g., generated from a separate schema file representing relationships of data in the first data for backup 104 or from processing the first data for backup 104 itself.

The backup system 102 is an example of a system implemented as computer programs on one or more computers in one or more locations, in which the systems, components, and techniques described in this specification are implemented. A network (not shown), such as a local area network (“LAN”), wide area network (“WAN”), the Internet, or a combination thereof, can connect elements included in the environment 100. The backup system 102 can use a single computer or multiple computers operating in conjunction with one another, including, for example, a set of remote computers deployed as a cloud computing service.

The backup system 102 can include several different functional components, including one or more engines or sub-engines. The engines or sub-engines can include one or more data processing apparatuses, can be implemented in code, or a combination of both. For instance, each of the scoring engine 106 and the action engine 160 can include one or more data processors and instructions that cause the one or more data processors to perform the operations discussed herein.

The various functional components of the backup system 102 can be installed on one or more computers as separate functional components or as different modules of a same functional component. For example, components of the backup system 102—e.g., the scoring engine 106 and the action engine 160—can be implemented as computer programs installed on one or more computers in one or more locations that are coupled to each through a network. In cloud-based systems for example, these components can be implemented by individual computing nodes of a distributed computing system.

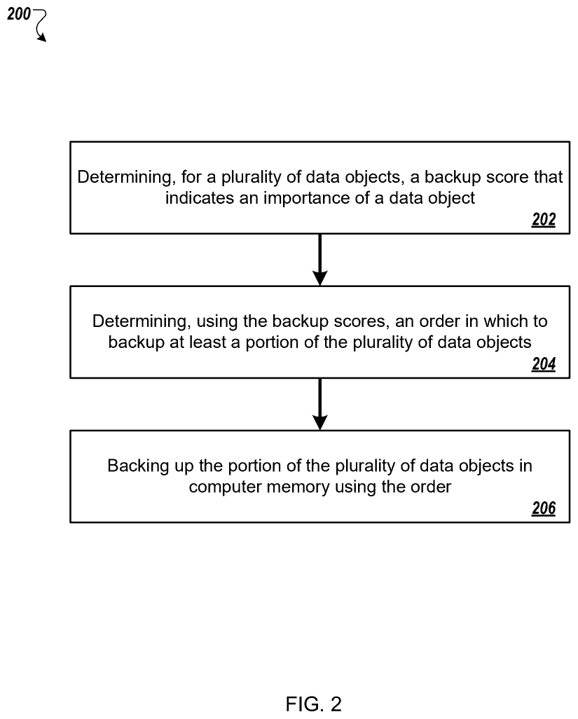

FIG. 2 is a flowchart of an example process 200 for backing up data. For convenience, the process 200 will be described as being performed by a system of one or more computers, located in one or more locations, and programmed appropriately in accordance with this specification. For example, a backup system, e.g., the backup system 102 of FIG. 1, appropriately programmed, can perform the process 200.

The process 200 includes determining, for a plurality of data objects, a backup score that indicates an importance of a data object (202). For example, the scoring engine 106 of the backup system 102 can generate the scores 150 representing backup scores for one or more data objects included in the second data for backup 140.

The process 200 includes determining, using the backup scores, an order in which to backup at least a portion of the plurality of data objects (204). For example, the action engine 160 of the backup system 102 can prioritize one or more data objects of the second data for backup 140 using the scores 150.

The process 200 includes backing up the portion of the plurality of data objects in computer memory using the order (206). For example, the backup system 102 can obtain and backup the second data for backup 140. The backup can be prioritized using scores generated, in part, using the previously archived data 107. The action engine 160 can backup high importance data at a first location with high storage costs, at a first higher frequency, with one or more data copies for redundancy, or a combination of these. The action engine 160 can backup data with lower importance at a second location with lower storage costs compared to the first location, at a frequency lower than the first frequency, or with no or fewer data copies, or a combination of these.

The action engine 160 can store important data in storage with efficient read or write processes. For example, the action engine 160 can select one or more data objects with a first priority score in a first range or satisfying one or more thresholds for storage at a first location with M.2 SSDs with high read or write speeds. The action engine 160 can select one or more data objects with a second priority score in a second range or not satisfying one or more thresholds for storage at a second location with M.2 SSDs with comparatively lower read or write speeds. The backup system 102, using the action engine 160, can then store data objects using the data storage selections, e.g., data objects obtained from the data storage 108 included in the second data for backup 140.

In some implementations, the process 200 includes configuring backup monitoring for a data object. For example, the backup system 102 can determine that a backup score for a first data object satisfies a score threshold. The backup system 102 can configure backup monitoring for the first data object in response to determining that the backup score for the first data object satisfies the score threshold. Backup monitoring can include monitoring of backup frequency or backup integrity of a given data object, such as the first data object. Because backup monitoring can require additional processing resources, monitoring can be reserved for a subset of data objects that satisfy a score threshold to maximize backup reliability for important data objects while minimizing processing requirements.

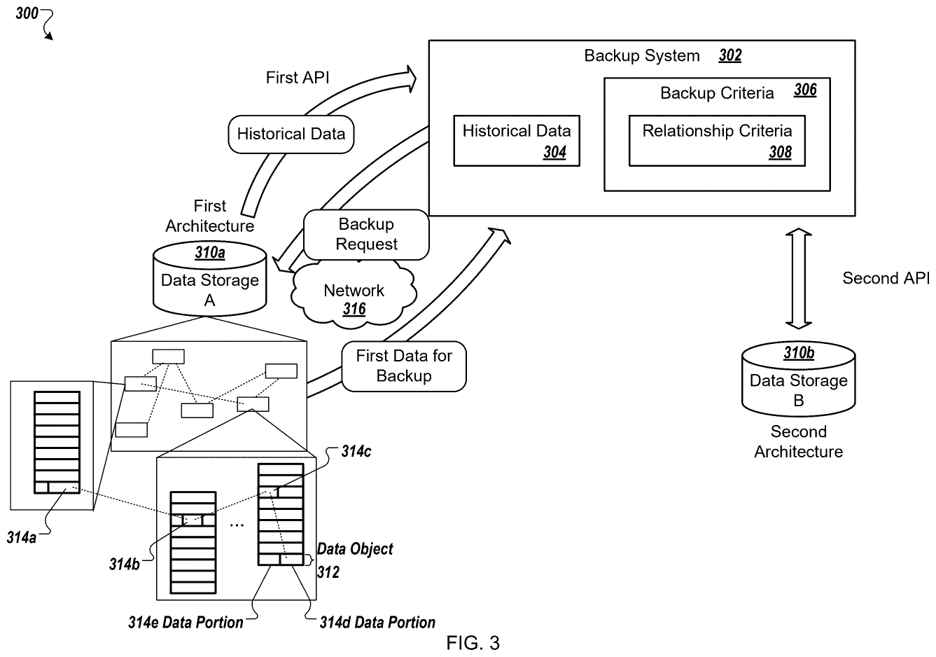

FIG. 3 depicts an example environment in which a backup system 302 backs up subsets of data objects using relationships between the subsets. The backup system 302 can back up subsets of data objects since an amount of data in a data storage A-B 310a-b might be impractical to backup, e.g., it would take too long, restrictions of an API that provide access to data in the respective data storage A-B 310a-b, e.g., that only allow retrieval of limited size portions of a data object, another appropriate reason, or any combination of these.

The backup system 302 can maintain, e.g., in a database, historical data 304 for data to be backed up. For instance, the historical data 304 can indicate a frequency at which data objects 312, data portions 314a-e of data objects, or both, are accessed. The historical data 304 can indicate relationships between data objects 312, data portions 314a-e of data objects, or both. In some examples, historical data 304 that indicates relationships can be a schema, e.g., the schema 142 described with reference to FIG. 1.

For example, when a data object 312 is a row in a table, e.g., in a database represented by the data storage A 310a, a data portion 314 can be a field in the row. The data objects can be in a single table. In some examples, and as shown in FIG. 3, the data objects can be in multiple different tables. For instance, at least a first data portion 314 is in a first data object of a first table, e.g., a data object grouping; at least a second data portion 314b is in a second data object of a second data object grouping; and at least three more data portions 314c-e are in various data objects of a third data object grouping. The third data portion 314c can be in a third data object while a fourth data portion 314d and a fifth data portion 314e can be in a fourth data object 312.

The historical data 304 can indicate relationships between the various data portions 314a-d. For instance, the first data portion 314a can be related to the data portions 314b-d either directly or indirectly. A direct relationship can indicate a relationship between two data portions without any intermediate relationships, such as the relationship between the first data portion 314a and the second data portion 314b or the relationship between the third data portion 314c and the fourth data portion 314d. An indirect relationship can indicate a relationship between two data portions with at least one intermediate relationship, such as the relationship between the second data portion 314b and the fourth data portion 314d or the relationship between the first data portion 314a and the fourth data portion 314d. As shown in FIG. 3, there is not a relationship between the first data portion 314a and the fifth data portion 314e.

A relationship can be represented by any appropriate type of data that indicates a reference or another appropriate type of relationship between two data portions. For instance, when a data portion is a field, a relationship can indicate that one of the data portions relies on the other data portion.

A relationship can be directional or non-directional. For instance, as described in more detail below, when a relationship is directionally, the backup system 302 can use the direction of the relationship when determining whether to backup a data portion. A directional relationship can indicate which data portion relies on, e.g., uses data from, the other data portion. When a relationship is non-directional, e.g., it doesn't matter which data portion relies on the other, the backup system 302 might not use a direction of the relationship when determining whether to back up a data portion.

The backup system 302 can receive the historical data 304, or at least a portion of the historical data 304, from the data storage A 310a. The backup system 302 can use a first API for the data storage A 310a to receive the historical data 304. The backup system 302 can receive the historical data 304 according to a backup schedule. The backup system 302 can receive the historical data 304 that indicates data portion relationships separate from or together with the historical data 304 that indicates access data. For instance, the backup system 302 can use a first API call to receive the relationship data and a second API call to receive the access data.

The backup system 302 uses the access data and one or more backup criteria 306 to determine one or more data portions 314a-e to backup. The backup criteria 306 can be any appropriate criteria. For instance, the backup criteria can include a criterion for the most frequently accessed, e.g., read or updated, data portion; the most referenced data portion, e.g., given a schema; or any combination of both. The backup system 302 can determine that a second data portion 314b is most frequently accessed, e.g., has an access frequency that satisfies an access frequency criterion, and should be backed up. The access frequency criterion can be a total number of accesses, a percentage of accesses against a predetermined threshold given a time period, a percentage of accesses against other accesses in a time period, or any combination of these.

The backup system 302 can determine which data portions to backup using time period data. The time period can be any appropriate time period, such as a day, a week, or a month. In some examples, the time period is a time period since a most recent backup process. In these examples, the access data can indicate a frequency at which some data portions were accessed since the most recent backup process.

The backup system 302 uses the relationship data and the determined data portions to select additional data portions for backing up. For example, when the backup system 302 uses the access data, schema, other appropriate data, or any combination of these, to identify a first group of data portions to back up, the backup system 302 can use the identify of the data portions in the first group and the relationship data to determine a second group of data portions to back up. This can include using the relationship data and the identification of the second data portion 314b to determine that the first data portion 314a, the third data portion 314c, and the fourth data portion 314d are candidate data portions for backing up. The backup system 302 can determine to backup all of these data portions in the second group or can use one or more of the backup criteria 306, e.g., one or more relationship criteria 308, to determine whether to backup a subset of these data portions.

The relationship criteria 308 can be any appropriate criteria that relate to relationships between data portions. For example, a relationship criterion, e.g., a distance criterion, can require that the relationship is no more than a predetermined number of data portions away. The distance criterion can indicate a maximum dependency level. When the predetermined number is two, the backup system 302 would determine that, when the first data portion 314a is flagged during an initial pass for backup, the second and third data portions 314b-c should be backed up and determine to skip backing up the fourth data portion 314d based on the first data portion 314a.

When the backup criteria 306, e.g., the relationship criteria 308 or other appropriate criteria, include a directional criterion, the backup system 302 can analyze the direction of the relationship when determining whether to backup related data portions. For example, the relationship criteria 308 can require that only data portions that rely on an initially determined data portion and are at most one data portion away. When the second data portion 314b is the initially determined data portion and relies on the first data portion 314a, while the second and third data portions 314c-d directly or indirectly rely on the third data portion, given these relationship criteria 308, the backup system 302 can determine to backup the third data portion 314c along with the second data portion 314b while determining to skip backing up the first data portion 314a and the fourth data portion 314d. The backup system 302 determines to skip backing up the first data portion 314a since the second data portion 314b relies on the first data portion 314a and the relationship criteria 308 only allow backing up of child data portions that rely on the second data portion 314b. The backup system determines to skip backing up the fourth data portion 314d because this data portion is two data portions away and the relationship criteria 308 require that secondary data portions are at most one data portion away, e.g., even though the fourth data portion 314d indirectly relies on the second data portion 314b.

In some examples, a single data portion might rely on multiple other data portions. For instance, the third data portion 314c might rely on both the second data portion 314b and the fourth data portion 314d. In these examples, when the relationship criteria 308 only allow backup of other data portions that directly or indirectly rely on an initially determined data portion, e.g., the second data portion 314b, the backup system 302 can determine to skip backing up another data portion because of this change in relationship. For instance, the backup system 302 can determine to backup the third data portion 314c and to skip backing up the fourth data portion 314d even though any distance criterion allows for backing up data portions that are two data portions away from the initially determined data portion. In this example, if the relationship criteria 308 were not directional, the backup system 302 would determine to backup the fourth data portion 314d. However, the backup system 302 might have the directional criterion because any changes to the second data portion 314b are more likely to affect, e.g., be represented by changes to, the third data portion 314c while not affecting the fourth data portion 314d.

The backup system 302 can determine related data portions for at least some of, e.g., each of, the initially determined data portions. For instance, when the backup system 302 initially determines, using the historical data, to backup the first data portion 314a and the fifth data portion 314e, the backup system 302 can determine, using the relationship data and the relationship criteria, the second group of data portions that should be backed up with the initially determined data portions.

In some implementations, the backup system 302 might perform the relationship analysis for some data portions multiple times. For example, when the backup system initially determines to backup the first data portion 314a and the third data portion 314c, the backup system 302 might analyze the fourth data portion 314d twice. During analysis for the first data portion 314a, the backup system 302 might determine to skip backup of the fourth data portion 314d based on the first data portion 314a and the relationship criteria 308. During analysis for the third data portion 314c, the backup system 302 might determine to backup the fourth data portion 314d based on the third data portion 314c and the relationship criteria 308. As a result, the backup system 302 would transmit a backup request for at least the first data portion 314a, the third data portion 314c, and the fourth data portion 314d, along with any other determined data portions.

In some instances, the backup system 302 might determine that there are not any related data portions that satisfy the relationship criteria 308. This might occur when a data portion, e.g., the fifth data portion 314e, does not have any relationships; when none of the relationships that the data portion has satisfy the relationship criteria, e.g., when the relationships are directional and don't satisfy a directional criterion; or in other appropriate situations.

The backup system 302 can generate a backup request that identifies the determined data portions. For instance, when the initially determined data portion is the second data portion 314b, the backup request can identify the first through fourth data portions 314a-d.

The backup system 302 transmits the backup request to the data storage A 310a, e.g., using the first API. The backup system 302 can use a network 316 to transmit the backup request to the data storage A 310a.

The backup system 302 receives, from the data storage A 310a, first data for backup. Given the backup request indicated above, the first data for backup would include at least the first through the fourth data portions 314a-d. The first data for backup would not include all of the data from the data storage A 310a. In some examples, the first data for backup might not include any entire data objects 312. This might occur when an entire data object is not identified during the initial analysis, e.g., given one or more access criteria or a schema, and is not identified during the secondary analysis, e.g., given the relationship criteria 308. In some examples, the first data for backup might include at least one entire data object but would not include only entire data objects, e.g., the first data would include at least some data portions from data objects for which other data portions are not included. This can include the first data including data for the fourth data portion 314d while not including data for the fifth data portion 314e, both of which are included in the data object 312.

In some implementations, the backup system 302 can use system architecture data to determine at least one data portion for backup. For example, different data architectures can have different APIs, such as the data storage A 310a having a first architecture with a first API and a data storage B 310b having a second, different architecture and a second, different API. Given the differences in the architectures, and optionally the corresponding APIs, the backup system 302 can use different backup criteria 306 for backup processes for the different architectures. For instance, a data hierarchy for first data objects maintained using the first architecture can be different than a data hierarchy for second data objects maintained using the second architecture. Given these data hierarchy differences, data objects in the first architecture might be farther away from each other relationally than if the data objects were maintained using the second architecture. As a result, a distance criterion for the first architecture might be greater than a corresponding distance criterion for the second architecture. The backup system 302 can use data representing the corresponding data architecture to select, from multiple backup criteria 306, the specific backup criteria 306 that apply to the corresponding system architecture.

The historical data 304 can be any appropriate type of data. For instance, the historical data can be generated from activity logs, such as process logs, transaction logs, repositories, asks, queries, metadata reports, other appropriate sources, or any appropriate combination of these. Any appropriate system can gather, generate, or both, the historical data 304. For example, the data storage A 310a, a system that manages the data storage A 310a, the backup system 302, or any combination of these, can generate the historical data 304.

The backup system 302, the data storages A-B 310a-b, or any combination of these, can each be examples of a system implemented as computer programs on one or more computers in one or more locations, in which the systems, components, and techniques described in this specification are implemented. The data storages A-B 310a-b can be examples of databases. The backup system 302 can be an example of the backup system 102. The network 316, such as a local area network (“LAN”), wide area network (“WAN”), the Internet, or a combination thereof, connects the backup system 302 with the data storages A-B 310a-b. The backup system 302, the data storages A-B 310a-b, or any combination of these, can use a single computer or multiple computers operating in conjunction with one another, including, for example, a set of remote computers deployed as a cloud computing service.

The backup system 302, the data storages A-B 310a-b, or any combination of these, can include several different functional components. For instance, the backup system 302 can include, as a functional component, a data portion selection engine, a backup request generation engine, or both. Any one or more of the components can include one or more data processing apparatuses, can be implemented in code, or a combination of both. For instance, each of the components can include one or more data processors and instructions that cause the one or more data processors to perform the operations discussed in this specification.

The various functional components of the backup system 302, the data storages A-B 310a-b, or any combination of these, can be installed on one or more computers as separate functional components or as different modules of a same functional component. For example, the components can be implemented as computer programs installed on one or more computers in one or more locations that are coupled to each through a network. In cloud-based systems for example, these components can be implemented by individual computing nodes of a distributed computing system.

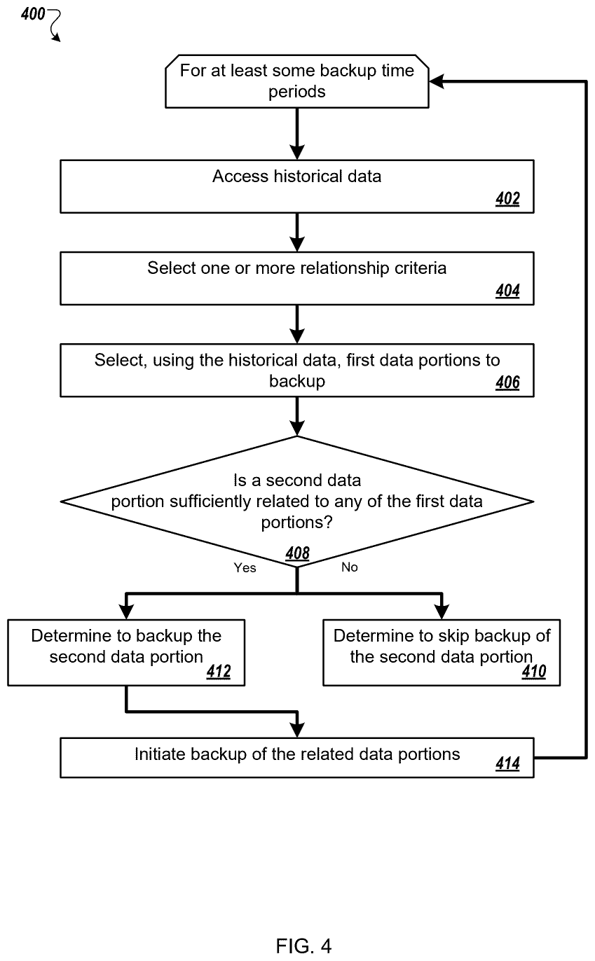

FIG. 4 is a flow diagram of an example process 400 for backing up related data portions. For example, the process 400 can be used by the backup system 302 from the environment 300.

For at least some backup time periods, a backup system accesses historical data (402). For instance, the backup system can receive the historical data from a data storage, a system associated with the data storage, or both, when the data storage includes data for the backup process that will occur during the respective backup time period. The system associated with the data storage can be a system that includes the data storage, e.g., database, or otherwise manages the data storage, e.g., includes access logs for the data storage.

The backup system selects one or more relationship criteria (404). For example, the backup system can use any appropriate data to select the relationship criteria for the backup process. The backup system can use data that indicates a system architecture, data that identifies relationship criteria specific to the data storage being backed up, other appropriate data, or any combination of these, to select the relationship criterion. In some examples, the backup system can select multiple, e.g. two or more, relationship criteria.

The backup system selects, using the historical data, first data portions to backup (406). For instance, the backup system can use, for the historical data, access data, a schema, other appropriate data, or any combination of these. The backup system can select the first data portions to back up during an initial data portion selectin process.

The first data portions are a subset of the data portions in the data storage. For example, one or more access criteria are defined such that the backup system does not select the entire data storage as the first data portions.

The data portions can be any appropriate data portions in the data storage. At least some of the data portions in the first data portions might not be part of the same data object as another data portion in the first data portions. Some of the data portions from the first data portions might be part of the same data object as another data portion in the first data portions. In these examples, combinations of data portions from the same data object might result in the backup of the entire data object. This would occur when each data portion in a single data object satisfies at least one of the backup criteria and the backup system 302 separately determines that each data portion satisfies at least one backup criteria.

The backup system determines whether there a second data portion that is sufficiently related to any of the first data portions (408). For instance, the backup system can use one or more relationship criteria to determine whether there are any second data portions that satisfy a relationship criterion for a data portion from the first data portions. The second data portions might not include any data portions in the first data portions. When the backup system determines that a first data portion is potentially related to another first data portion, the backup system can determine to skip analysis of that first data portion that is also a second data portion since that data portion is already identified for backing up. This can reduce computational resource usage.

The backup system can analyze any appropriate number of data portions from the data storage as part of this analysis. For instance, the backup system can use one or more relationship criteria and a schema to determine whether the data portions identified as potentially related to one of the first data portions satisfy at least one of the one or more relationship criteria. As a result, if the schema indicates that any particular second data portion is not potentially related to any of the first data portions, the backup system might not analyze those data portions.

The backup system can determine to skip backup of the second data portion (410). In response to determining that a second data portion is not sufficiently related to any of the first data portions, the backup system can determine to skip backing up the second data portion. For instance, the backup system can determine to skip backup of any second data portions that were not analyzed, or that do not satisfy a least one of the one or more relationship criteria for any of the first data portions.

The backup system determines to backup the second data portion (412). In response to determining that the second data portion is sufficiently related to at least one of the first data portions, the backup system can determine to backup the second data portion. This can include adding an identifier for the second data portion to a list of data portions to back up. This can occur when the second data portion has a relationship that satisfies at least one of the one or more relationship criteria for at least one of the first data portions. When a second data portion is identified for being backed up based on a first of the first data portions, and the second data portion is potentially related to a second one of the first data portions, the backup system can determine to skip analysis of the second data portion based on the second one of the first data portions since the second data portion is already identified for being backed up. This can reduce computational resource usage.

The backup system initiates backup of the related data portions (414). For example, the backup system uses the list of identified data portions to initiate the backup process of those data portions. This can include generating a message that identifies the data portions and transmitting the message to a data storage. The message can include instructions, call an API, or both, that cause the data storage to transmit copies of data for the identified data portions to the backup system. The backup system can store, e.g., in long term memory, the received copies of data for the identified data portions.

The order of operations in the process 400 described above is illustrative only, and backing up the related data portions can be performed in different orders. For example, the process 400 can access the historical data, select first data portions, and then select one or more relationship criteria. In some examples, the process 400 can select the one or more relationship criteria and then access the historical data.

In some implementations, the process 400 can include additional operations, fewer operations, or some of the operations can be divided into multiple operations. For example, the process 400 might not include operation 404, e.g., when the same relationship criteria are always used.

In some implementations, at least some operations in the process 400 are performed for different backup time periods. Since the historical data for the different time periods might be different, the process 400 can include selection of different first data portions, and selection of different sufficiently related second data portions, for different iterations of the process 400 for the different backup time periods. For instance, a backup during a first time period might include backup of data portions that are not backed up during a second, later time period. A backup of a first time period might not include backup of data portions that are backed up during a second, later time period.

For situations in which the systems discussed here collect or otherwise access personal or business information, the systems may provide data owners with an opportunity to control whether programs or features collect or otherwise access the information. Thus, the data owners may have control over how information is collected or accessed and used during a backup process.

In this specification, the term “database” can broadly to refer to any collection of data: the data does not need to be structured in any particular way, or structured at all, and it can be stored on storage devices in one or more locations. A database can be implemented on any appropriate type of memory.

In this specification the term “engine” can broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

Operations can occur substantially concurrently in that the operations need not be exactly concurrent but can overlap at least in part. For instance, a first operation can begin and sometime after that a second operation can begin while the first operation is still occurring. Execution of the two operations, whether by the same system or different systems, can be substantially concurrently. In some examples, two operations can execute substantially concurrently when they have the same start time, same end time, or both.

In this specification, the term likely can mean that there is a likelihood that something might occur and that the likelihood satisfies a likelihood threshold. For instance, when determining that an object is more likely to be accessed, e.g., read or updated, a system would determine a first likelihood that the object will be accessed, and one or more second likelihoods for other objects. The system would then determine whether the first likelihood satisfies, e.g., is greater than or equal to, the one or more second likelihoods by comparing pairs of values. If so, the system determines that the object is more likely to be used. If not, the system determines that the object is not more likely to be used. When selecting the ten most likely used, this process can occur by ranking the likelihoods and selecting the ten objects with the highest likelihoods.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

In some implementations, when a device or system transmits data to another device or system, the transmission of the data, such as a message, can cause the other device or system to perform one or more actions. For instance, transmission of a message that includes an instruction to a camera can cause the camera to capture one or more images, transmit one or more images to the device or system, or a combination of both.

In addition to the embodiments of the attached claims and the embodiments described above, the following numbered embodiments are also innovative.

Embodiment 1 is a method comprising determining, for each of two or more data objects from the plurality of data objects and using metadata for the respective data object, a backup score that indicates an importance of the respective data object; determining different priority levels for two or more subsets of the plurality of data objects based at least in part on the backup scores; and backing up at least one of the subsets of the plurality of data objects according to the respective priorities of the subsets.

Embodiment 1 may provide one or more of the following technical advantages or effects: For example, by determining which data objects, e.g., entities, to prioritize for backup, techniques described can reduce the time or processing power required for a given backup of data, e.g., by using the priorities to assign groups of data objects, such as specific tables within a priority group, to different types of storage to optimize data storage and retrieval. Optimizing data storage and retrieval can include reducing latency in data storage and retrieval, e.g., by allowing high priority data objects, e.g., that are more likely to be retrieved later, to be stored in memory devices with faster read or write speeds or low priority data objects, e.g., that are less likely to be retrieved later, to be stored in memory devices with slower read or write speeds or that consume less energy.

The technology described in this specification can be implemented to improve scheduling of different processing activities. For example, actions that include backing up data identified as high priority can take precedence over other actions to be performed by processors—e.g., backing up data with lower priority. Priority can be used for monitoring data—e.g., by increasing monitoring actions, such as ensuring an accessible backup, for data identified as high priority compared to lower priority data. Changes in priority can be used as an indicator of significant data storage changes, e.g., in the schema or metadata.

Embodiment 2 is the method of embodiment 1, wherein: determining the backup score that indicates the importance of the respective data object in the plurality of data objects includes determining the backup score based on at least one or more relationship obtained from a schema that indicates relationships between different types of data objects in the plurality of data objects.

Embodiment 3 is the method of embodiment 2, wherein: the different types of data objects include at least one of different types of tables or different types of fields.

Embodiment 4 is the method of any one of embodiments 1-3, comprising: as part of the data backup process: backing up the schema.

Embodiment 5 is the method of any one of embodiments 1-4, wherein: determining the backup score that indicates the importance of the respective data object in the plurality of data objects includes determining the backup score based on at least an impact ratio or an entity rank of the respective data object.

Embodiment 6 is the method of any one of embodiments 1-5, wherein: determining the backup score includes determining the backup score based at least in part on how many changes to the data object were made within a time period.

Embodiment 7 is the method of any one of embodiments 1-6, wherein: determining the backup score includes determining the backup score based at least in part on how many references to the respective data object are included in other data objects in the plurality of data objects.

Embodiment 8 is the method of any one of embodiments 1-7, comprising: determining the number of references to the respective data object that are included in the other data objects in the plurality of data objects, where the number of references is based at least in part on one or more artifacts for the other data objects that do not include the content of the other data objects.

Embodiment 9 is the method of any one of embodiments 1-8, wherein: determining the backup score includes: determining, for a child object of the respective data object in the plurality of data objects, a child backup score; and determining, for the respective data object, the backup score based at least in part on the child backup score.

Embodiment 10 is the method of any one of embodiments 1-9, wherein: determining the backup score includes: determining child backup scores for all children of the respective data object; and determining a combination score from the child backup scores and basing the backup score of the respective data object at least in part on the combination score.

Embodiment 11 is the method of embodiment 10, wherein: determining the combination score from the child backup scores includes: obtaining a discount factor; and applying the discount factor to a summation of the child backup scores.

Embodiment 12 is the method of any one of embodiments 1-11, wherein: determining the backup score includes: determining a number of references to the respective data object; and determining the backup score based at least in part on the number of references to the respective data object.

Embodiment 13 is the method of embodiment 12, wherein: the respective data object is a data field.

Embodiment 14 is the method of any one of embodiments 12-13, comprising: determining whether the backup score of the respective data object satisfies a score threshold; and in response to determining that the backup score of the respective data object satisfies the score threshold, configuring backup monitoring for the respective data object.

Embodiment 15 is the method of any one of embodiments 1-14, wherein: determining the backup score of the respective data object includes determining the backup score based at least in part on a backup score determined for a previously backed up instance of the respective data object.

Embodiment 16 is the method of any one of embodiments 1-15, comprising: prior to backing up at least one of the subsets of the plurality of data objects: determining, using the backup scores, (1) a frequency for backing up at least one of the subsets of the plurality of data objects and (2) a location for backing up at least one of the subsets of the plurality of data objects, where backing up at least one of the subsets of the plurality of data objects at the frequency and in the location.

Embodiment 17 is the method of embodiment 16, wherein: the location for storing the portion of the plurality of data objects indicates a type, from a plurality of types, of computer memory to use for backup.

Embodiment 18 is the method of any one of embodiments 1-17, wherein: determining the backup score is done using only the metadata for the respective object.

Embodiment 19 is the method of any one of embodiments 1-18, comprising: backing up, based at least in part on the backup scores, one or more of the plurality of data objects to a first location and a different second location.

Embodiment 20 is a method comprising determining, using priority data, to backup a first proper subset of data portions from a first data object, the first data object including the first proper subset and a second proper subset; determining, using relationship data that identifies relationships between data portions of different data objects from a plurality of data objects, to backup a third proper subset of data portions from a second, different data object, the second, different data object including the third proper subset and a fourth proper subset; determining, using the priority data, to skip a backup process for the second proper subset and fourth proper subset; and initiating backup of the first proper subset and the third proper subset.

Embodiment 20 may provide one or more of the following technical advantages or effects: reduced computational resource usage, increased data security, or both. For instance, by backing up data portions without necessarily backing up entire data objects that include the data portions, the systems and methods can reduce an amount of memory required for a backup, reduce an amount of computational cycles to execute the backup process, or both. The systems and methods described in this specification can increase data security by backing up data portions using priority data, e.g., that are most likely to be used by a source system.

Embodiment 21 is the method of embodiment 20, wherein determining to backup the third proper subset of data portions from the second, different data object uses the relationship data that identifies which data portions of the different data objects rely on other data portions from other data objects.

Embodiment 22 is the method of any one of embodiments 20-21, wherein determining, using relationship data that identifies the relationships between the data portions of the different data objects from the plurality of data objects, to backup the third proper subset of data portions from the second, different data object, the second, different data object including the third proper subset and the fourth proper subset comprises: determining, for each data portion in at least the third proper subset of data portions and the fourth proper subset of data portions, a distance of the respective data portions from the first proper subset of data portions using the relationship data, the distance in a plurality of distances for the third proper subset and the fourth proper subset; determining, for at least some distances in the plurality of distances, whether the distance satisfies one or more distance criteria; in response to determining for one or more first distances that satisfy the one or more distance criteria and are for a respective data portion from the third proper subset of data portions, determining to backup the respective data portion that is included in the third proper subset of data portions; and in response to determining for one or more second distances that do not satisfy the one or more distance criteria and are for a respective data portion from the fourth proper subset of data portions, determining to skip backing up the respective data portion that is included in the fourth proper subset of data portions.

Embodiment 22 may provide one or more of the following technical advantages or effects: selection of fewer related subsets, e.g., represented by the third proper subset; selection of related subsets that are more likely to rely on data from the first subset, or both.

Embodiment 23 is the method of embodiment 22, the operations comprising: determining a system architecture of a storage that maintains the first data object and the second, different data object; and selecting, from a plurality of distance criteria, the one or more distance criteria using the system architecture.

Embodiment 23 may provide one or more of the following technical advantages or effects: enabling the method to operate different for different architectures that have different properties for relationships among subsets.

Embodiment 24 is the method of any one of embodiments 20-23, wherein determining, using relationship data that identifies the relationships between the data portions of the different data objects from the plurality of data objects, to backup the third proper subset of data portions from the second, different data object, the second, different data object including the third proper subset and the fourth proper subset comprises: determining, for each data portion in the third proper subset of data portions, whether the data portion relies directly or indirectly on data from at least one data portion from the first proper subset of data portions; and in response to determining that the data portion relies directly or indirectly on data from at least one data portion from the first proper subset of data portions, determining to backup the respective data portion that is included in the third proper subset of data portions.

Embodiment 24 may provide one or more of the following technical advantages or effects: use of different types of relationships between subsets, e.g., direct or indirect. This can enable the process to more accurately select different subsets for backup, exclude subsets from backup, or both.

Embodiment 25 is the method of any one of embodiments 20-24, the operations comprising: accessing historical data that indicates, for each of one or more data portions of the first data object, one or more instances when the respective data portion was accessed; determining, using the historical data and for at least some of the one or more data portions, whether the one or more instances when the respective data portion was accessed satisfies at least one of one or more access criteria; and generating the priority data using a result of the determination whether the one or more instances when the respective data portion was accessed satisfies at least one of the one or more access criteria.

Embodiment 25 may provide one or more of the following technical advantages or effects: backing up most read, most updated, or both, data, e.g., without backing up all data.

Embodiment 26 is the method of embodiment 25, wherein: accessing the historical data comprises accessing, for a first backup process, historical data for a first time period, the operations comprising: accessing, for a second, different backup process, second historical data for a second, different time period; determining, using the second historical data, to backup a fifth proper subset of data portions from the first data object, at least some data portions included in the first proper subset or the fifth proper subset not included in the other proper subset; determining, using second relationship data, to backup a sixth proper subset of data portions from a third, different data object; and initiating backup of the fifth proper subset and the sixth proper subset.

Embodiment 27 is the method of embodiment 26, wherein the at least some data portions included in the first proper subset or the fifth proper subset not included in the other proper subset comprises a data portion included in the first proper subset that is not included in the fifth proper subset.

Embodiment 28 is the method of any one of embodiments 26-27, wherein the at least some data portions included in the first proper subset or the fifth proper subset not included in the other proper subset comprises a data portion included in the fifth proper subset that is not included in the first proper subset.

Embodiment 29 is the method of any one of embodiments 20-28, the operations comprising: determining, using the relationship data that identifies relationships between data portions of different data objects from the plurality of data objects, to backup a fifth proper subset of data portions from a third, different data object, the third, different data object including the fifth proper subset and a sixth proper subset; and determining, using the priority data, to skip a backup process for the sixth proper subset, wherein: initiating backup comprises initiating the backup of the first proper subset, the third proper subset, and the fifth proper subset.

Embodiment 30 is the method of any one of embodiments 20-29, the operations comprising: accessing a schema that indicates relationships between different data portions of the data objects, wherein: determining to backup the third proper subset of data portions from the second, different data object uses the schema that indicates relationships between different data portions of the data objects.

Embodiment 31 is the method of embodiment 30, wherein a data portion of the data object comprises a field.

Embodiment 32 is the method of embodiment 31, wherein the field comprises a field from an entry in a database table.

Embodiment 33 is a system comprising: one or more computers and one or more storage devices storing instructions that are operable, when executed by the one or more computers, to cause the one or more computers to perform the method of any one of embodiments 1 to 32.

Embodiment 34 is a computer program carrier encoded with a computer program, the program comprising instructions that are operable, when executed by one or more computers, to cause the one or more computers to perform the method of any one of embodiments 1 to 32.

Embodiment 35 is the computer program carrier of embodiment 34, wherein the computer program carrier is a propagated, e.g., non-transitory, signal.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures, such as spreadsheets, relational databases, or structured files, may be used.

Particular implementations have been described. Other implementations are within the scope of the following claims. For example, the operations recited in the claims, described in the specification, or depicted in the figures can be performed in a different order and still achieve desirable results. In some implementations, multitasking and parallel processing may be advantageous.

What is claimed is:

1. A system comprising one or more computers and one or more storage devices on which are stored instructions that are operable, when executed by the one or more computers, to cause the one or more computers to perform operations comprising:
determining, using priority data, to backup a first proper subset of data portions from a first data object, the first data object including the first proper subset and a second proper subset;
determining, using relationship data that identifies relationships between data portions of different data objects from a plurality of data objects, to backup a third proper subset of data portions from a second, different data object, the second, different data object including the third proper subset and a fourth proper subset;
determining, using the priority data, to skip a backup process for the second proper subset and fourth proper subset; and
initiating backup of the first proper subset and the third proper subset.

2. The system of claim 1, wherein determining to backup the third proper subset of data portions from the second, different data object uses the relationship data that identifies which data portions of the different data objects rely on other data portions from other data objects.

3. The system of claim 1, wherein determining, using relationship data that identifies the relationships between the data portions of the different data objects from the plurality of data objects, to backup the third proper subset of data portions from the second, different data object, the second, different data object including the third proper subset and the fourth proper subset comprises:
determining, for each data portion in at least the third proper subset of data portions and the fourth proper subset of data portions, a distance of the respective data portions from the first proper subset of data portions using the relationship data, the distance in a plurality of distances for the third proper subset and the fourth proper subset;
determining, for at least some distances in the plurality of distances, whether the distance satisfies one or more distance criteria;
in response to determining for one or more first distances that satisfy the one or more distance criteria and are for a respective data portion from the third proper subset of data portions, determining to backup the respective data portion that is included in the third proper subset of data portions; and
in response to determining for one or more second distances that do not satisfy the one or more distance criteria and are for a respective data portion from the fourth proper subset of data portions, determining to skip backing up the respective data portion that is included in the fourth proper subset of data portions.

4. The system of claim 3, the operations comprising:
determining a system architecture of a storage that maintains the first data object and the second, different data object; and
selecting, from a plurality of distance criteria, the one or more distance criteria using the system architecture.

5. The system of claim 1, wherein determining, using relationship data that identifies the relationships between the data portions of the different data objects from the plurality of data objects, to backup the third proper subset of data portions from the second, different data object, the second, different data object including the third proper subset and the fourth proper subset comprises:
determining, for each data portion in the third proper subset of data portions, whether the data portion relies directly or indirectly on data from at least one data portion from the first proper subset of data portions; and
in response to determining that the data portion relies directly or indirectly on data from at least one data portion from the first proper subset of data portions, determining to backup the respective data portion that is included in the third proper subset of data portions.

6. The system of claim 1, the operations comprising:
accessing historical data that indicates, for each of one or more data portions of the first data object, one or more instances when the respective data portion was accessed;
determining, using the historical data and for at least some of the one or more data portions, whether the one or more instances when the respective data portion was accessed satisfies at least one of one or more access criteria; and
generating the priority data using a result of the determination whether the one or more instances when the respective data portion was accessed satisfies at least one of the one or more access criteria.

7. The system of claim 6, wherein:
accessing the historical data comprises accessing, for a first backup process, historical data for a first time period, the operations comprising:
accessing, for a second, different backup process, second historical data for a second, different time period;
determining, using the second historical data, to backup a fifth proper subset of data portions from the first data object, at least some data portions included in the first proper subset or the fifth proper subset not included in the other proper subset;
determining, using second relationship data, to backup a sixth proper subset of data portions from a third, different data object; and
initiating backup of the fifth proper subset and the sixth proper subset.

8. The system of claim 7, wherein the at least some data portions included in the first proper subset or the fifth proper subset not included in the other proper subset comprises a data portion included in the first proper subset that is not included in the fifth proper subset.

9. The system of claim 7, wherein the at least some data portions included in the first proper subset or the fifth proper subset not included in the other proper subset comprises a data portion included in the fifth proper subset that is not included in the first proper subset.

10. The system of claim 1, the operations comprising:
determining, using the relationship data that identifies relationships between data portions of different data objects from the plurality of data objects, to backup a fifth proper subset of data portions from a third, different data object, the third, different data object including the fifth proper subset and a sixth proper subset; and
determining, using the priority data, to skip a backup process for the sixth proper subset, wherein:
initiating backup comprises initiating the backup of the first proper subset, the third proper subset, and the fifth proper subset.

11. The system of claim 1, the operations comprising:
accessing a schema that indicates relationships between different data portions of the data objects, wherein:
determining to backup the third proper subset of data portions from the second, different data object uses the schema that indicates relationships between different data portions of the data objects.

12. The system of claim 11, wherein a data portion of the data object comprises a field.

13. The system of claim 12, wherein the field comprises a field from an entry in a database table.

14. A computer-implemented method comprising:
determining, using priority data, to backup a first proper subset of data portions from a first data object, the first data object including the first proper subset and a second proper subset;
determining, using relationship data that identifies relationships between data portions of different data objects from a plurality of data objects, to backup a third proper subset of data portions from a second, different data object, the second, different data object including the third proper subset and a fourth proper subset;
determining, using the priority data, to skip a backup process for the second proper subset and fourth proper subset; and
initiating backup of the first proper subset and the third proper subset.

15. The method of claim 14, wherein determining to backup the third proper subset of data portions from the second, different data object uses the relationship data that identifies which data portions of the different data objects rely on other data portions from other data objects.

16. The method of claim 14, wherein determining, using relationship data that identifies the relationships between the data portions of the different data objects from the plurality of data objects, to backup the third proper subset of data portions from the second, different data object, the second, different data object including the third proper subset and the fourth proper subset comprises:
determining, for each data portion in at least the third proper subset of data portions and the fourth proper subset of data portions, a distance of the respective data portions from the first proper subset of data portions using the relationship data, the distance in a plurality of distances for the third proper subset and the fourth proper subset;
determining, for at least some distances in the plurality of distances, whether the distance satisfies one or more distance criteria;
in response to determining for one or more first distances that satisfy the one or more distance criteria and are for a respective data portion from the third proper subset of data portions, determining to backup the respective data portion that is included in the third proper subset of data portions; and
in response to determining for one or more second distances that do not satisfy the one or more distance criteria and are for a respective data portion from the fourth proper subset of data portions, determining to skip backing up the respective data portion that is included in the fourth proper subset of data portions.

17. The method of claim 16, comprising:
determining a system architecture of a storage that maintains the first data object and the second, different data object; and
selecting, from a plurality of distance criteria, the one or more distance criteria using the system architecture.

18. The method of claim 14, wherein determining, using relationship data that identifies the relationships between the data portions of the different data objects from the plurality of data objects, to backup the third proper subset of data portions from the second, different data object, the second, different data object including the third proper subset and the fourth proper subset comprises:
determining, for each data portion in the third proper subset of data portions, whether the data portion relies directly or indirectly on data from at least one data portion from the first proper subset of data portions; and
in response to determining that the data portion relies directly or indirectly on data from at least one data portion from the first proper subset of data portions, determining to backup the respective data portion that is included in the third proper subset of data portions.

19. The method of claim 14, comprising:
accessing historical data that indicates, for each of one or more data portions of the first data object, one or more instances when the respective data portion was accessed;
determining, using the historical data and for at least some of the one or more data portions, whether the one or more instances when the respective data portion was accessed satisfies at least one of one or more access criteria; and
generating the priority data using a result of the determination whether the one or more instances when the respective data portion was accessed satisfies at least one of the one or more access criteria.

20. One or more computer storage media encoded with instructions that, when executed by one or more computers, cause the one or more computers to perform operations comprising:
determining, using priority data, to backup a first proper subset of data portions from a first data object, the first data object including the first proper subset and a second proper subset;
determining, using relationship data that identifies relationships between data portions of different data objects from a plurality of data objects, to backup a third proper subset of data portions from a second, different data object, the second, different data object including the third proper subset and a fourth proper subset;
determining, using the priority data, to skip a backup process for the second proper subset and fourth proper subset; and
initiating backup of the first proper subset and the third proper subset.
